(19) United States
(12) Patent Application Publication
(10) Pub. No.: US 2025/0077822 A1
(43) Pub. Date: Mar. 6, 2025

(54) METHOD OF PRODUCING ELECTRONIC APPARATUS AND PRINTING APPARATUS

(71) Applicant: SEIKO EPSON CORPORATION, Tokyo (JP)

(72) Inventors: Akio TAKAMOTO, Nagano (JP); Tsutomu KASAI, Nagano (JP)

(21) Appl. No.: 18/818,687

(22) Filed: Aug. 29, 2024

(30) Foreign Application Priority Data
Aug. 31, 2023 (JP) 2023-140881

(51) Int. Cl. G06K 15/02

(52) U.S. Cl. CPC G06K 15/1805; G06K 15/1886

(57) ABSTRACT

In place of first data stored in a first partition of a storage medium, setting data stored in a second partition of the storage medium is stored in the first partition, the second partition is changed to a partition containing a third partition, the setting data stored in the first partition is stored in the third partition, the first data acquired via an interface is stored in the first partition in place of the setting data stored in the first partition, and producing an electronic apparatus having the third partition. The first data is general-purpose data used in a plurality of electronic apparatuses, but not used for production of the electronic apparatus.

The present application is based on, and claims priority from JP Application Serial Number 2023-140881, filed Aug. 31, 2023, the disclosure of which is hereby incorporated by reference herein in its entirety.

### BACKGROUND

### 1. Technical Field

The present disclosure relates to a method of producing an electronic apparatus and a printing apparatus.

### 2. Related Art

In related art, a technique for updating firmware of an electronic apparatus is known. For example,
JP-A-2021-135674 discloses a technique of updating firmware by preparing a NAND-Flash partitioned into at least three areas of a firmware area, a user area, and a backup area and storing the firmware in the backup area.
JP-A-2021-135674 is an example of the related art.

In related art, when the backup area is not secured in advance, the update of the firmware is not performed.

### SUMMARY

A method of producing an electronic apparatus according to an aspect of the present disclosure includes, in place of first data stored in a first partition of a storage medium, storing setting data stored in a second partition of the storage medium in the first partition, after storing the setting data in the first partition, changing the second partition to a partition containing a third partition, storing the setting data stored in the first partition in the third partition, after storing the setting data in the third partition, storing the first data acquired via an interface in the first partition in place of the setting data stored in the first partition, and producing an electronic apparatus having the third partition, wherein the first data is general-purpose data used in a plurality of electronic apparatuses, but not used for production of the electronic apparatus.

A printing apparatus according to an aspect of the present disclosure includes an interface, a processor that updates a storage medium having a first partition and a second partition according to an update program acquired via the interface, and a printing mechanism that performs printing using first data stored in the first partition, wherein the processor stores setting data stored in the second partition in the first partition in place of the first data, after storing the setting data in the first partition, changes the second partition to a partition containing a third partition, stores the setting data stored in the first partition in the third partition, and, after storing the setting data in the third partition, stores the first data acquired via the interface in the first partition in place of the setting data stored in the first partition, and the first data is general-purpose data used in a plurality of electronic apparatuses and is used for printing, but not used for partitioning operation.

### BRIEF DESCRIPTION OF THE DRAWINGS

FIG. 1 is a block diagram of a printer.

FIG. 2 schematically shows a storage area of an EEPROM;

FIG. 3 is a block diagram of a computer.

FIG. 4 is a diagram for explanation of phase information.

FIG. 5 is a flowchart of firmware transmission processing.

FIG. 6 is a flowchart of firmware update processing.

FIG. 7 schematically shows the storage area of the EEPROM when a main program at a version value 1.1 is stored.

FIG. 8 is a flowchart of processing according to the main program at the version value 1.1.

FIG. 9 schematically shows the storage area of the EEPROM when the main program at a version value 1.2 is stored.

FIG. 10 is a flowchart of processing according to the main program at the version value 1.2.

FIG. 11 schematically shows the storage area of the EEPROM when setting data is restored.

FIG. 12 schematically shows the storage area of the EEPROM when the main program at a version value 2.0 is stored.

FIG. 13 is a flowchart of processing according to the main program at the version value 2.0.

### DESCRIPTION OF EMBODIMENTS

An embodiment of the present disclosure will now be described in the following order.
(1) System Configuration:
(1-1) Configuration of Printer:
(1-2) Configuration of Computer:
(2) Update of Firmware Program:
(2-1) Firmware Transmission Processing:
(2-2) Firmware Update Processing:
(3) Update Example:
(4) Other Embodiments:
(1) System Configuration:

A method of producing an electronic apparatus according to the embodiment is realized by a system in which an electronic apparatus and an external apparatus cooperatively operate. The electronic apparatus is an apparatus in which a partition of a storage device is changed, and the form of the apparatus is not limited. The embodiment is described here on the assumption that the electronic apparatus is a printer 10. The external apparatus is an apparatus that cooperatively operates with the printer 10 and the form of the apparatus is not limited. The embodiment is described here on the assumption that a general-purpose computer 20 such as a personal computer or a portable terminal is the external apparatus. In the embodiment, the printer 10 and the computer 20 are communicably connected to each other. The printer 10 can communicate with the computer 20 and exchange various kinds of information. The form of the communication is not limited, but may be wired communication or wireless communication. The communication standard is not limited, but the communication may be made at various communication standards such as LAN (Local Area Network) and USB (Universal Serial Bus).

### (1-1) Configuration of Printer:

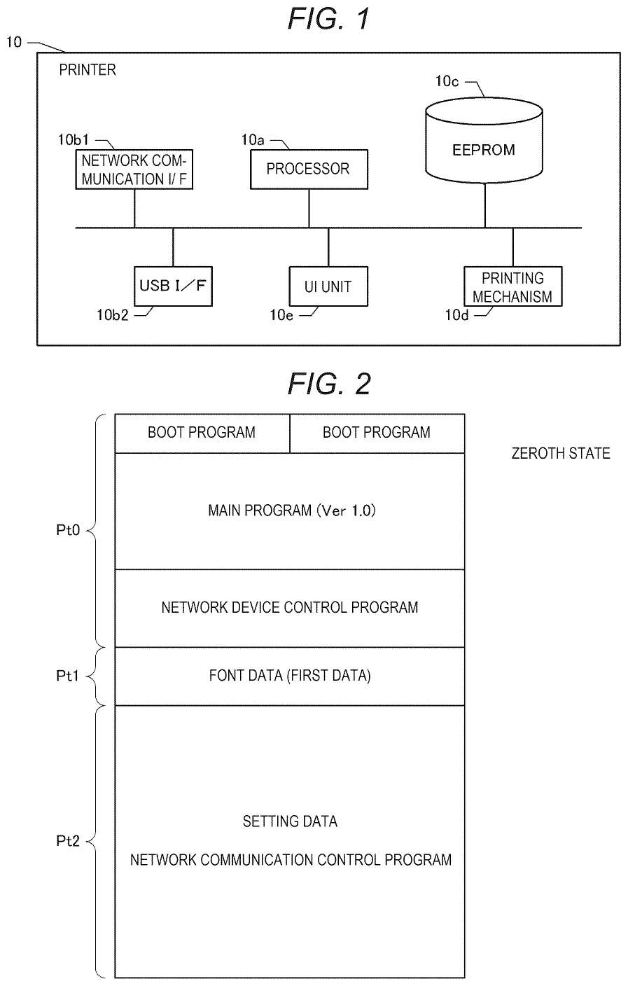

FIG. 1 shows a configuration of the printer 10. The printer 10 includes a processor 10a, a network communication I/F 10b1, a USB I/F 10b2, an EEPROM (Electrically Erasable Programmable Read-Only Memory) 10c, a printing mechanism 10d, and a UI unit 10e. The processor 10a includes a CPU, a ROM, a RAM, and the like (not shown), and can control the respective parts of the printer 10 by executing various programs stored in the EEPROM 10c. The processor 10a may be implemented by a single chip, may be implemented by a plurality of chips, or may be implemented as an SoC with various functional blocks. For example, an ASIC may be employed instead of the CPU, or the CPU and the ASIC may cooperatively operate. When each apparatus in the embodiment includes a processor, the processor can be implemented in various forms like the processor 10a.

The network communication I/F 10b1 is a communication interface for performing communication via a network connectable to a plurality of apparatuses by wired communication or wireless communication. The printer 10 can communicate with other apparatuses connected via a network via the network communication I/F 10b1.

The USB I/F 10b2 is an interface for performing communication according to the USB standard. The printer 10 can communicate with another apparatus connected by a USB cable via the USB I/F 10b2.

The printing mechanism 10d is a section executing printing and prints contents on a print medium. The printing method is not limited. Various methods such as an inkjet method, a toner method, and a sublimation method can be employed. The print medium is not limited to printing paper, but may be various print mediums such as cloth, pottery, and resin. The printing mechanism 10d includes an actuator and various devices, a sensor, a drive circuit, a mechanical component, and the like for printing on various media. The printing mechanism 10d may be configured to realize various functions relating to printing, for example, a stapling function.

The UI unit 10e includes at least any of a touch panel display, various keys, a switch, an LED, and the like. The touch panel display includes a display panel that displays various kinds of information, for example, a status of the printer 10 and a remaining amount of ink, and a touch detection panel superimposed on the display panel, and detects a touch operation. The LED performs lighting or blinking display showing a status and the like of the printer 10. The processor 10a can acquire the details of operation of an administrator via the UI unit 10e.

The EEPROM 10c is a nonvolatile memory including a semiconductor storage medium, and stores various types of data. The form of the EEPROM 10c is not limited. For example, a NAND EEPROM or the like is assumed as the EEPROM 10c. The data stored in the EEPROM 10c contains various types of data. For example, print data transmitted from the computer 20 may be temporarily stored. The EEPROM 10c also stores a firmware program for controlling the printer 10 and data used for operating the printer 10.

The printer 10 according to the embodiment can update the firmware program. FIG. 2 schematically shows a storage area for data related to update among the data stored in the EEPROM 10c. In the EEPROM 10c, partitions as logically partitioned storage areas are defined. In FIG. 2, the storage area of the EEPROM 10c is divided into a zeroth partition Pt0, a first partition Pt1, and a second partition Pt2.

The zeroth partition Pt0 contains a program for operating the printer 10. In the example shown in FIG. 2, the partition contains a boot program, a main program, and a network device control program. In FIG. 2, an example in which these programs are stored in the zeroth partition Pt0 as a single partition is assumed, however, these programs may be stored in separate partitions.

The boot program is a program executed when the printer 10 is started for various types of initialization and the like. In the example shown in FIG. 2, since the boot program is duplicated, even when data of one is damaged, the printer 10 can be started by data of the other.

The main program is a program for controlling the printer 10. The main program may include various programs, and controls the processor 10a to perform image processing based on print data transmitted from the computer 20 or the like, control of the printing mechanism 10d for printing, and the like. In the embodiment, the main program contains a USB communication control program for communication with the computer 20 via the USB I/F 10b2. By executing the USB communication control program contained in the main program, the processor 10a can communicate with another apparatus, the computer 20 connected by the USB cable in the embodiment via the USB I/F 10b2. The USB communication control program may be a program separate from the main program, but is preferably stored in the zeroth partition Pt0.

A version value is associated with the main program. The version value is indicated by numerical values on the left and right of a dot. When the firmware program is updated, the numerical value on the left side of the version value is incremented. On the other hand, in the update process of the firmware program, respective programs for updating the firmware program are stored in the zeroth partition Pt0. There are a plurality of the programs, and the programs are sequentially updated to other programs as the update procedure of the firmware program proceeds. The version value of the program used in the update process of the firmware program is indicated by the numerical value on the right side of the dot. When the update procedure of the firmware program proceeds, the numerical value on the right side of the version value is sequentially incremented. In the example shown in FIG. 2, it is assumed that the version value of the main program is 1.0. When the update of the firmware program is completed, the version value becomes 2.0. As the update procedure of the firmware program proceeds, the version value changes to 1.1 and 1.2.

The network device control program is a program for controlling the network communication I/F 10b1. When the processor 10a executes the network device control program, the processor 10a can control the hardware of the network communication I/F 10b1.

The first partition Pt1 of the EEPROM 10c stores font data as the first data. The font data is data indicating a font when characters and the like are displayed or printed by the printer 10. In the embodiment, a dedicated partition for storing font data is set in advance, and the dedicated partition is referred to as the first partition Pt1.

Setting data and the network communication control program are stored in the second partition Pt2 of the EEPROM 10c. The setting data is data used when the printer 10 operates, and includes data specific to the printer 10. The specific data may vary depending on individual conditions including the machine body and the user of the printer 10. For example, the specific data includes a password and an SSID for communication and a threshold individually set at factory shipment. The latter includes detection thresholds of various sensors.

The network communication control program is a program for exchanging information using the network communication I/F 10b1. When the processor 10a executes the network communication control program, the processor 10a can communicate with the computer 20 via the network in a predetermined procedure. The network device control program stored in the zeroth partition is a program for processing related to the hardware of the network communication I/F 10b1, that is, processing of a layer including a physical layer. The network device control program is a program containing software related to communication for processing of a layer including an application layer.

In the embodiment, the second partition Pt2 is a storage area in which data having a data volume that can dynamically change such as setting data is stored. Therefore, in the initial state, the capacity of the second partition Pt2 has a margin. In a state in which the setting data and the network communication control program are stored as shown in FIG. 2, the storage capacity of the second partition Pt2 has a margin as a free space.

### (1-2) Configuration of Computer:

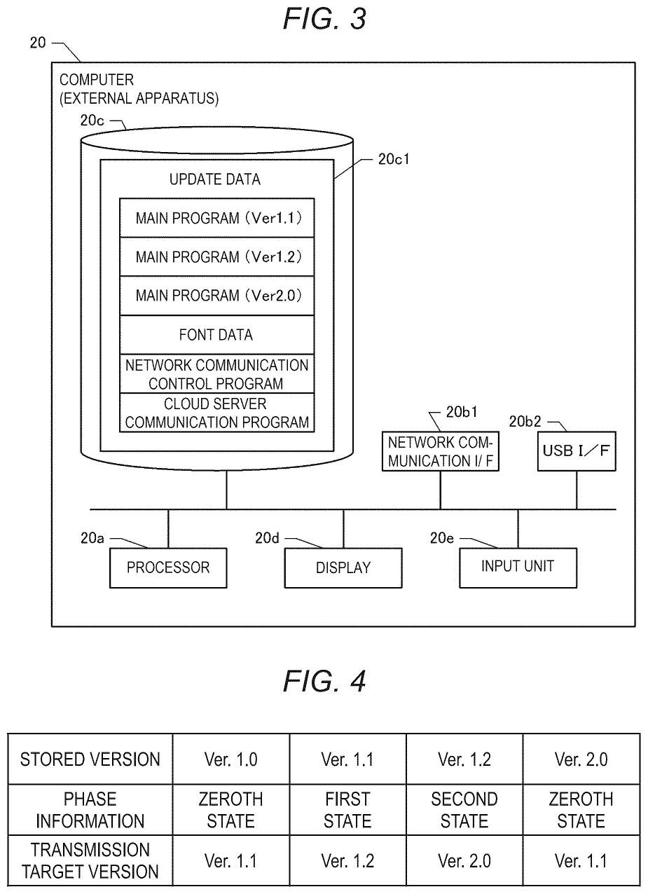

FIG. 3 is a block diagram showing a configuration of the computer 20. The computer 20 includes a processor 20a, a network communication I/F 20b1, a USB I/F 20b2, a nonvolatile memory 20c, a display 20d, and an input unit 20e. The processor 20a includes a CPU, a ROM, a RAM, and the like (not shown), and can control the respective parts of the computer 20 by executing various programs stored in the nonvolatile memory 20c.

The network communication I/F 20b1 is a communication interface for performing communication via a network connectable to a plurality of apparatuses by wired communication or wireless communication. The computer 20 can communicate with the printer 10 connected via a network to the network communication I/F 20b1.

The USB I/F 20b2 is an interface for performing communication according to the USB standard. The computer 20 can communicate with the printer 10 connected by a USB cable to the USB I/F 20b2.

The display 20d is a display device that displays any image. The input unit 20e is a device through which a user performs an input operation, and includes, for example, a keyboard and a mouse. The user can input an intention of the user by operating the input unit 20e while visually recognizing an image or a character displayed on the display 20d.

The nonvolatile memory 20c is a storage medium that can store any data. In the embodiment, update data 20cl used for update of the firmware program of the printer 10 is stored in the nonvolatile memory 20c. The update data 20cl is data transmitted from the computer 20 to the printer 10 in the update process of the firmware program.

In the embodiment, since the main program of the zeroth partition is sequentially overwritten in the update process, the update data 20c1 contains the main programs at the version values 1.1, 1.2, and 2.0. The update data 20cl contains font data, the network communication control program, and a cloud server communication program.

The cloud server communication program is a new firmware program installed in the printer 10 with the update of the firmware program in the embodiment, that is, the update of the version value from 1.0 to 2.0. Here, an example in which communication with a cloud server is inoperative when the version value is 1.0, but the communication with the cloud server is operative when the version value is 2.0 by the cloud server communication program is assumed. Obviously, the new firmware program is not limited to a program for communication with the cloud server.

In the embodiment, the update data 20cl is data not requiring backup. That is, the data specific to the printer 10 may differ for each machine body of the printer 10, and may vary during the operation of the printer 10. Therefore, when the update of the firmware program with the deletion of this type of data is performed, backup is required. On the other hand, regarding general-purpose data that can be generated by the computer 20 as an external apparatus of the printer 10 or can be prepared in advance, the data can be restored even without backup by transfer from an apparatus other than the printer 10.

Accordingly, in the embodiment, the firmware program is updated with backup of the setting data as the data specific to the printer 10, but without backup of the general-purpose data. However, since the setting data contains secret information such as a password and an SSID for communication as described above, it is not preferable to transmit the setting data to the computer 20 as an external apparatus of the printer 10.

Therefore, it is preferable to backup the setting data in the EEPROM 10c inside the printer 10, however, in the configuration in which the storage area for backup is secured in the printer 10 as in related art, the storage area of the storage medium is not efficiently used. In the embodiment, the setting data is backed up, not in the dedicated storage area for backup, but in the partition storing the data other than the setting data for execution of the update of the firmware program.

### (2) Update of Firmware Program:

Hereinafter, the update of the firmware program will be described in detail. In the embodiment, as described above, the main program of the zeroth partition is sequentially overwritten in the update process of the firmware program, and the main program is updated from version 1.0 to 2.0 after a plurality of times of overwriting. In the configuration in which the version is updated through a plurality of phases, when the processing is interrupted due to some cause such as power outage, if the current phase is unknown, it becomes difficult to restart the update from the appropriate processing.

Accordingly, in the embodiment, the current phase is indicated using phase information. FIG. 4 is a diagram for explanation of the phase information. FIG. 4 shows versions of the main program stored in the printer 10, the phase information corresponding to the stored versions, and versions of the main program as transmission targets from the computer 20 to the printer 10.

When the version values of the main program stored in the printer 10 are 1.0, 1.1, and 1.2, the phase information is a zeroth state, a first state, and a second state, respectively. When the version value becomes 2.0, the phase information becomes the zeroth state again. For update of the version value from 1.0 to 2.0, when the phase information is the zeroth state, the version value of the main program to be transmitted from the computer 20 to the printer 10 is 1.1. When the phase information is the first state and the second state, the version value of the main program to be transmitted from the computer 20 to the printer 10 is 1.2 and 2.0, respectively.

When the update of the firmware program is completed and the version value becomes 2.0, the phase information becomes the zeroth state. When the firmware program is updated again, the version value of the main program to be transmitted from the computer 20 to the printer 10 is 2.1.

The phase information may be stored in the zeroth partition of the printer 10, and may be stored in various storage areas. The phase information may be defined in various forms, may be various kinds of identification information, or may be the version value itself. The phase information may be more finely defined. For example, the phase information may be defined according to the combination of the version value of the main program and the state of the partition. Further, the zeroth state when the version value of the main program is 1.0 and the zeroth state when the version value of the main program is 2.0 may be distinguished from each other.

In a configuration in which phase information is defined as described above, when the user performs a predetermined instruction operation on the UI unit 10e of the printer 10, the firmware update processing is executed in the printer 10. When the firmware update processing is started, an instruction to start the firmware transmission processing is transmitted from the printer 10 to the computer 20, and the computer 20 executes the firmware transmission processing. Note that, in the embodiment, since the network communication control program is temporarily deleted in the process of the firmware update processing, the network communication is inoperative in the process of the update processing. Accordingly, in the embodiment, communication required in the process of the firmware update processing is performed via the USB I/Fs 10b2 and 20b2.

### (2-1) Firmware Transmission Processing:

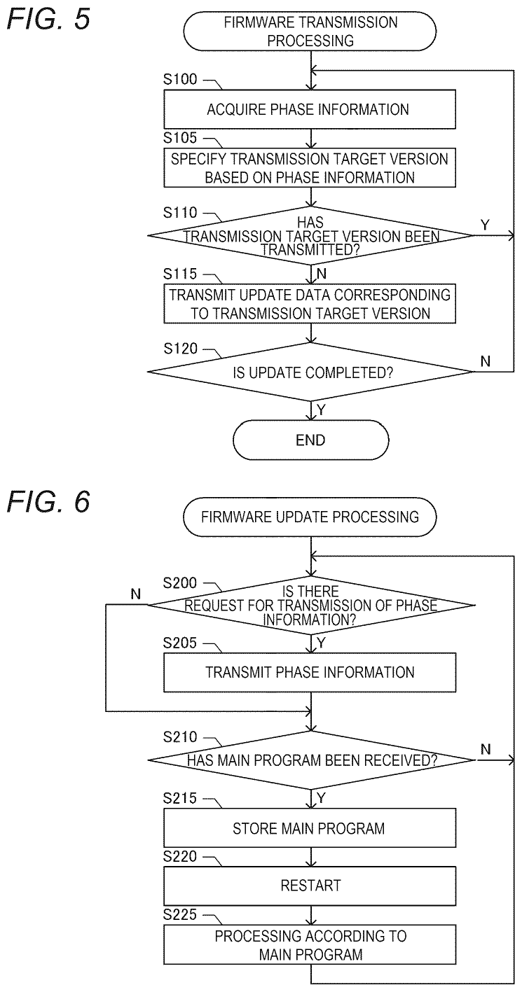

FIG. 5 shows the firmware transmission processing executed in the computer 20. When the firmware transmission processing is started, the processor 20a acquires the phase information (step S100). That is, the processor 20a outputs a transmission request for the phase information to the printer 10 via the USB I/F 20b2.

When the transmission request is made, phase information indicating the current phase is transmitted from the printer 10 to the computer 20. The processor 20a acquires the phase information via the USB I/F 20b2, and specifies a transmission target version based on the phase information (step S105). That is, the processor 20a specifies the transmission target version corresponding to the phase information indicating the current phase based on the correspondence relationship shown in FIG. 4.

Then, the processor 20a determines whether the transmission target version specified at step S105 has already been transmitted to the printer 10 (step S110). At step S110, when a determination that the transmission target version has been transmitted is not made, the processor 20a transmits the main program corresponding to the transmission target version (step S115). That is, the processor 20a refers to the nonvolatile memory 20c, extracts the main program corresponding to the transmission target version from the update data 20cl, and transmits the main program to the printer 10 via the USB I/F 20b2.

Then, the processor 20a determines whether the update has been completed (step S120). That is, when the transmission target version transmitted at step S115 is the last version, the processor 20a determines that the update has been completed. For example, in a case of the update of the version value from 1.0 to 2.0, when the transmission target version is the version value 2.0, the processor determines that the update has been completed.

When not determining that the update has been completed at step S120, or determining that the transmission target version has been transmitted at step S110, the processor 20a repeats the processing at step S100 and the subsequent steps. On the other hand, when determining that the update has been completed at step S120, the processor 20a ends the firmware transmission processing. Here, the processor 20a may guide the end of the firmware update using the display 20d or the like. The user can recognize that the firmware update is ended based on the guidance.

### (2-2) Firmware Update Processing:

FIG. 6 shows firmware update processing executed in the printer 10. When the firmware update processing is started, the processor 10a determines whether there has been a request for transmission of the phase information from the computer 20 (step S200). That is, the processor 10a monitors whether there is a request for transmission of the phase information from the computer 20 based on the information received by the USB I/F 10b2.

At step S200, when a determination that there has been a request for transmission of the phase information is made, the processor 10a acquires the phase information corresponding to the current version value of the main program stored in the predetermined storage area of the EEPROM 10c. The processor 20a then controls the USB I/F 10b2 to transmit the phase information to the computer 20 (step S205).

When step S205 is executed, or when the determination that there has been a transmission request for the phase information is not made at step S200, the processor 20a determines whether the main program has been received (step S210). That is, when the phase information is transmitted at step S205, the computer 20 transmits the main program corresponding to the phase information to the printer 10 at step S115. The printer 10 monitors the USB I/F 10b2 and determines whether the main program has been received. At step S210, when a determination that the main program has been received is not made, the processor 10a repeats the processing at step S200 and the subsequent steps.

On the other hand, when the determination that the main program has been received is made at step S210, the processor 10a stores the main program in the EEPROM 10c (step S215). The storage location of the main program is determined in advance, and the processor 10a stores the received main program in a predetermined storage location in the zeroth partition Pt0.

Then, the processor 10a restarts the printer 10 (step S220), and executes processing according to the main program (step S225). That is, the processor 10a restarts the printer 10 and executes the updated main program at step S215. The details of the processing according to the main program will be described later.

When executing step S225, the processor 10a repeats the processing at step S200 and the subsequent steps. According to the above described processing, at each time when the main program corresponding to the phase information is received, steps S215 to S225 are executed, and the firmware update processing is executed in phases. When the firmware update processing is ended, the printer 10 may continue the operation based on the processing of the updated firmware, may be powered off, or may be restarted.

### (3) Update Example

Next, an update example according to the firmware update processing will be described. Here, the firmware update processing will be described phase by phase. The computer 20 serving as a control apparatus that communicates with the printer 10 acquires phase information from the printer 10 via the USB I/F 20b2 as the interface, and executes a process of producing the printer 10 according to the phase information. That is, when the phase information is the zeroth state, the main program at the version value 1.1 is transmitted from the computer 20 to the printer 10 at step S115. In this case, the printer 10 stores the main program at the version value 1.1 in the zeroth partition of the EEPROM 10c at step S215.

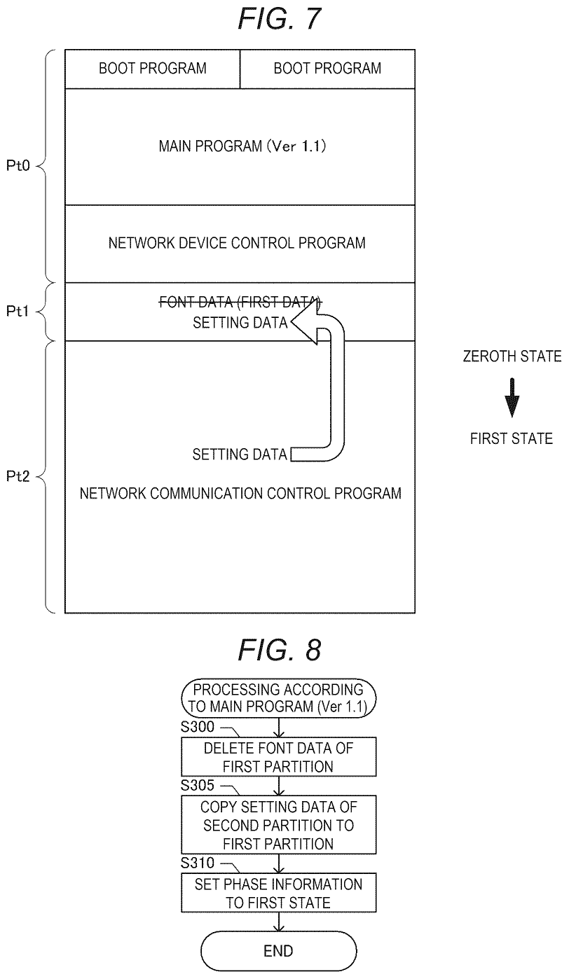

FIG. 7 schematically shows the storage area of the EEPROM 10c when the main program at the version value 1.1 is stored. Compared with the state shown in FIG. 2, the main program at the version value 1.1 is stored in the zeroth partition Pt0 in FIG. 7. When the restart at step S220 is performed in the state in which the main program at the version value 1.1 is stored in the zeroth partition Pt0, the processor 10a performs processing according to the main program at step S225 based on the main program at the version value 1.1.

FIG. 8 is a flowchart showing processing according to the main program at the version value 1.1. In this processing, the processor 10a deletes the font data of the first partition Pt1 (step S300). FIG. 7 shows that the font data is deleted by superimposition of a straight line on the font data in the first partition Pt1.

Then, the processor 10a copies the setting data of the second partition Pt2 to the first partition Pt1 (step S305). In FIG. 7, the copy of the setting data stored in the second partition Pt2 to the first partition Pt1 is indicated by an open arrow. As described above, the processor 10a performs processing of storing the setting data stored in the second partition Pt2 in the first partition in place of the font data as the first data stored in the first partition Pt1 of the EEPROM 10c according to the main program at the version value 1.1.

Then, the processor sets the phase 10a information to the first state (step S310). That is, the processor 10a sets the phase information indicating the production phase of the printer 10 to the first state in response to when the storage of the setting data in the first partition Pt1 is finished. According to the configuration, the computer 20 may be easily notified of the production phase of the printer 10.

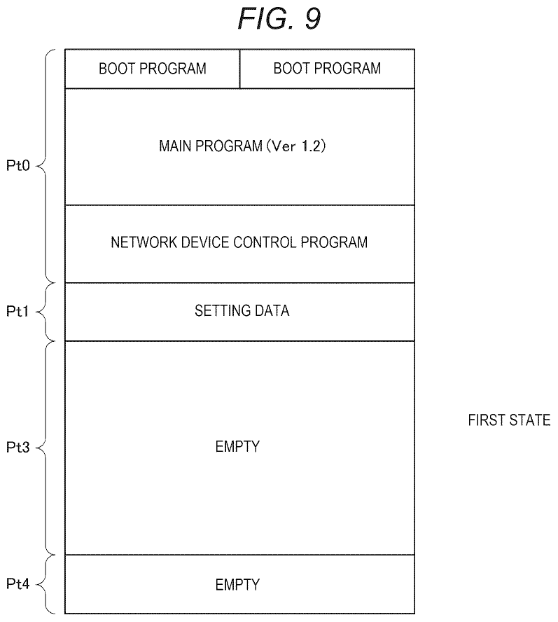

When the phase information is set to the first state, the processor 20a of the computer 20 executes step S115 through the determinations at steps $100 to S110. Specifically, at step S105, the processor 20a determines that the transmission target version is the main program at the version value 1.2. At step S115, the processor 20a transmits the main program at the version value 1.2 to the printer 10 via the USB I/F 20b2. At step S215, the printer 10 stores the main program at the version value 1.2 in the zeroth partition Pt0 of the EEPROM 10c. FIG. 9 shows a state in which the main program at the version value 1.2 is stored in the zeroth partition Pt0.

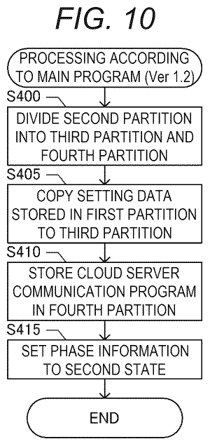

When restart at step S220 is performed with the main program at the version value 1.2 stored in the zeroth partition Pt0, the processor 10a performs processing according to the main program at step S225 based on the main program at the version value 1.2. FIG. 10 is a flowchart showing processing according to the main program at the version value 1.2. In this processing, the processor 10a divides the second partition Pt2 into the third partition Pt3 and the fourth partition Pt4 (step S400). FIG. 9 shows a state after the storage area as the second partition Pt2 is divided into the third partition Pt3 and the fourth partition Pt4. The above described processing is processing of changing the second partition Pt2 to a partition containing the third partition Pt3 after the setting data is stored in the first partition Pt1. When the partition is divided, the information stored before the division is deleted. Accordingly, as shown in FIG. 9, the third partition Pt3 and the fourth partition Pt4 after the division are empty.

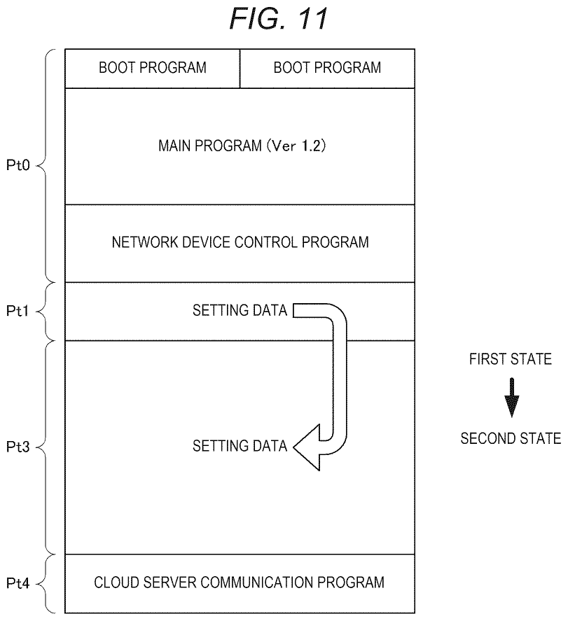

Then, the processor 10a copies the setting data stored in the first partition Pt1 to the third partition (step S405). That is, the setting data backed up in the EEPROM 10c of the printer 10 is restored. In FIG. 11, a state in which the setting data stored in the first partition Pt1 is copied to the second partition Pt2 is indicated by an open arrow.

Then, the processor 10a stores the cloud server communication program in the fourth partition Pt4 (step S410). That is, the processor 10a acquires the cloud server communication program from the computer 20 via the USB I/F 10b2, and stores the program in the fourth partition Pt4. FIG. 11 shows a state after the cloud server communication program is stored in the fourth partition Pt4. According to the above described processing, the firmware program not present before the update can be installed in the fourth partition Pt4.

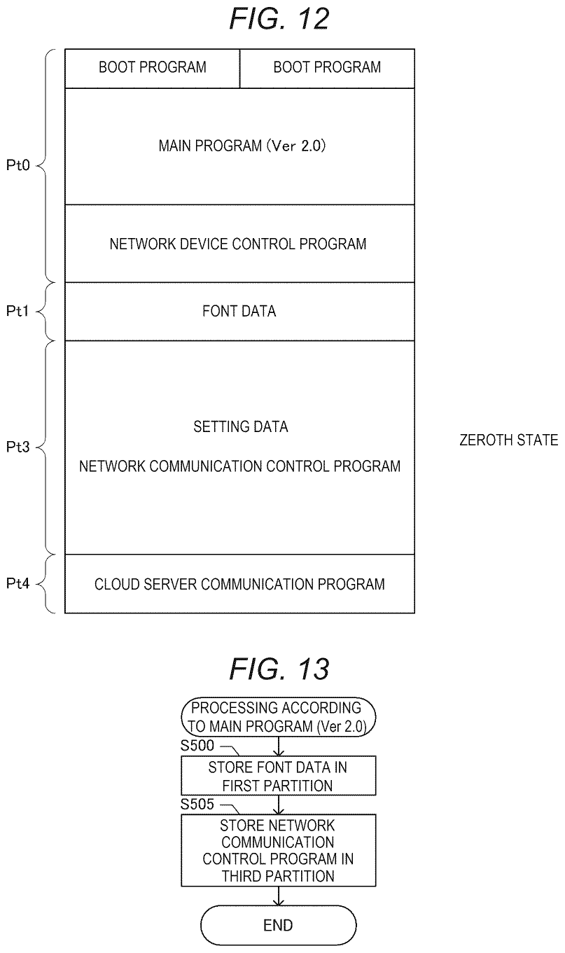

Then, the processor 10a sets the phase information to the second state (step S415). That is, the processor 10a sets the phase information to the second state in response to when the storage of the setting data in the third partition Pt3 is finished. When the phase information is set to the second state, the processor 20a of the computer 20 executes step S115 through the determinations at steps S100 to S110. Specifically, at step S105, the processor 20a determines that the transmission target version is the main program at the version value 2.0. At step S115, the processor 20a transmits the main program at the version value 2.0 to the printer 10 via the USB I/F 20b2. At step S215, the printer 10 stores the main program at the version value 2.0 in the zeroth partition Pt0 of the EEPROM 10c. FIG. 12 shows a state in which the main program at the version value 2.0 is stored in the zeroth partition Pt0.

When restart at step S220 is performed with the main program at the version value 2.0 stored in the zeroth partition Pt0, the processor 10a performs processing according to the main program at step S225 based on the main program at the version value 2.0. FIG. 13 is a flowchart showing processing according to the main program. In this processing, the processor 10a stores font data in the first partition Pt1 (step S500). That is, the processor 10a acquires the font data from the computer 20 via the USB I/F 10b2 and stores the font data in the first partition Pt1. According to the above described processing, after the setting data is stored in the third partition Pt3 at step S405, the font data as first data acquired via the interface is stored in the first partition Pt1 at step S500 in place of the setting data stored in the first partition Pt1.

Further, the processor 10a stores the network communication control program in the third partition (step S505). That is, the processor 10a acquires the network communication control program from the computer 20 via the USB I/F 10b2 and stores the program in the third partition Pt3. Thereafter, the processor 10a can perform network communication. FIG. 12 shows a state after the font data is stored in the first partition Pt1 and the network communication control program is stored in the third partition Pt3. Thereby, a printer storing data as shown in FIG. 12 is completed from a printer storing data as shown in FIG. 2. In other words, a printer with the third partition Pt3 is completed from a printer without the third partition Pt3.

According to the above described processing, since the setting data is backed up in the first partition Pt1 in which the font data is stored, the setting data can be backed up without securement of the dedicated backup area. Therefore, even when the setting data stored in the second partition Pt2 is deleted with the division of the second partition Pt2, the restoration can be performed based on the setting data stored in the first partition Pt1. Since the first partition Pt1 is the storage area for font data, it is not necessary to secure a dedicated storage area in the printer 10 for backup of setting data. Therefore, it is not necessary to excessively increase the storage area of the EEPROM 10c.

The font data, the network communication control program, the main program, and the like other than the setting data are general-purpose data used in a plurality of printers 10. Accordingly, it is not necessary to perform backup in the EEPROM 10c in the printer 10, and general-purpose data can be restored using data or the like stored in the computer 20 as an external apparatus. It is not necessary to secure a dedicated storage area in the printer 10 for backup of general-purpose data. Therefore, it is not necessary to excessively increase the storage area of the EEPROM 10c.

Although the setting data may contain secret information, it is not necessary to transfer the setting data to the outside of the printer 10 in the embodiment. Accordingly, leakage of secret information can be prevented. Further, even when a contract such as a confidentiality obligation or the like is required for handling of the setting data in an external apparatus, it is not necessary to transfer the setting data to the outside of the printer 10 in the embodiment, and accordingly, it is not necessary to make a contract for firmware update.

In order to handle the setting data in an external apparatus, it may be necessary to purchase an undisclosed program not open to the public. However, in the embodiment, it is not necessary to transfer the setting data to the outside of the printer 10, and it is not necessary to handle the setting data for firmware update in an external apparatus and it is not necessary to purchase an undisclosed program. A terminal of a memory reader/writer is soldered to the terminal of the EEPROM 10c of the printer 10, and thereby, the information stored in the EEPROM 10c can be backed up and restored. However, such an operation is complicated, and it is necessary to prepare a memory reader/writer. In the embodiment, since it is not necessary to transfer the setting data to the outside of the printer 10, it is not necessary to handle the setting data in an external apparatus for firmware update, complicated work is unnecessary and a memory reader/writer is unnecessary.

In the embodiment, the printer 10 operates based on the main programs (firmware) at the version values 1.1, 1.2, and 2.0 stored in the zeroth partition Pt0 of the EEPROM 10c. The printer 10 operates based on these main programs to produce the printer 10 having the third partition. Therefore, the printer 10 can operate according to the program in the printer 10, not an instruction from the computer 20 as an external apparatus, to produce the printer 10.

Further, in the embodiment, the production of the printer 10 proceeds according to the phase information indicating the production phase of the printer 10. Accordingly, it is not necessary for the user to be aware of the current phase of the plurality of phases and perform management to transmit a program suitable for the current phase to the printer 10. Therefore, the firmware update processing over the plurality of phases may be executed very easily.

Further, even when the processing is interrupted due to a problem such as an interruption of power supply in the middle of the firmware update processing over the plurality of phases, the processing can be easily restarted. That is, after the interruption, the user performs a predetermined instruction operation on the UI unit 10e of the printer 10, and thereby, the firmware update processing is executed in the printer 10. When the firmware update processing is started again, an instruction to start the firmware transmission processing is transmitted from the printer 10 to the computer 20, and the computer 20 executes the firmware transmission processing. As a result, the processing shown in FIGS. 5 and 6 is executed again, and restarted from appropriate processing corresponding to the phase information.

### (4) Other Embodiments

The above described embodiment is an example for implementing the present disclosure, and various other embodiments can be employed. For example, the apparatus configuration of the printing system is not limited to the configuration shown in FIG. 1, but the printer 10 may be a multifunction peripheral having a scanning function and the like. Further, in the above described embodiment, the network communication becomes inoperative in the process of the firmware update processing and the USB communication does not become inoperative, however, the inoperative standard may be another standard. For example, a configuration in which near field communication such as Bluetooth (registered trademark) becomes inoperative and the USB communication does not become inoperative may be employed as an embodiment. Various combinations of the communication standards may be employed. Any combination may be employed as long as communication between the printer 10 and the computer 20 is performed using a standard that does not become inoperative.

The storage medium may be any medium that can set partitions and store freely selected information in each partition and can be realized by the NAND EEPROM as in the above described embodiment, but the form is not limited thereto. The partition may be a storage area in a specific range formed by logical partition of the storage area of the storage medium as another area. The number of partitions and capacity of the storage medium are not limited.

The first data is general-purpose data used in a plurality of electronic apparatuses, but not used for production of an electronic apparatus. That is, the first data is data general-purposely used in a plurality of electronic apparatuses and irrelevant to the settings specific to an electronic apparatus. Since the first data is not used for the production of an electronic apparatus, the first data is not referred to in the production process of an electronic apparatus, that is, the process related to the update of the partition.

As a result, the first data may be deleted from the storage medium in the production process of an electronic apparatus and easily restored. The first data may be data stored in an external apparatus outside an electronic apparatus, or may be data that can be backed up from an electronic apparatus to an external apparatus. The types of data include various data other than the font data as in the above described embodiment. For example, data for forming a user interface, various image data, and the like may be the first data.

On the other hand, data specific to an electronic apparatus and data containing secret information that is prohibited from being transferred from an electronic apparatus to an external apparatus is not the first data. The types of data include various data other than the setting data of the electronic apparatus as in the above described embodiment. For example, data on closed access without a contract for handling secret information and the like is not the first data.

The setting data includes data specific to an electronic apparatus and referred to when the electronic apparatus is operated. The specific data includes data specific to each individual electronic apparatus, and is not general-purpose data used in a plurality of electronic apparatuses. When the setting data is restored as data different from the original setting data due to an error occurring in the restoration after the backup, the electronic apparatus may not normally operate. The setting data may include data that should not be transferred to an external apparatus or data on closed access without a contract for handling secret information in order to ensure security. Accordingly, the setting data is not transferred to an external apparatus and backed up inside an electronic apparatus. That is, the setting data is backed up from the second partition to the first partition.

When the setting data is backed up in the first partition or when the first data is stored in the first partition, the processing of deleting the previous data may be performed in advance or the processing of overwriting the previous data with the data may be performed. Furthermore, when the setting data is backed up in the first partition, a part of the previous first data may be left. For example, when the setting data has a plurality of font data, the setting data may be backed up with one font data left and the other font data deleted.

The method of changing the second partition to the partition containing the third partition is not limited to the configuration in which the second partition is divided into the third partition and the fourth partition. For example, in a configuration in which the second partition and another partition are present, a storage area in which the second partition and the other partition are combined may be changed to the third partition or may be changed to three or more partitions containing the third partition. In any case, the operation of changing the second partition to the partition containing the third partition involves deletion of the original data stored in the partition relevant to the change. Therefore, the setting data as non-general-purpose data stored in the second partition is backed up in the first partition irrelevant to the change.

The interface is an interface for realizing communication with an external apparatus outside an electronic apparatus. Since the first data is acquired via the interface, the first data is transmitted from an external apparatus to an electronic apparatus. The standard of the interface is not limited, but an interface at a standard that does not become inoperative in the production process of an electronic apparatus is used. The external apparatus may be a general-purpose computer, a portable storage medium, a server connected via a communication network, or various apparatuses.

The zeroth partition may store firmware for operating an electronic apparatus. That is, the firmware for controlling normal operation in an electronic apparatus, for example, a printing apparatus to perform printing operation is stored in the zeroth partition. Obviously, the firmware stored in the zeroth partition may operate an electronic apparatus in the process of the production of an electronic apparatus.

The phase information may indicate the phase of production of an electronic apparatus. That is, in order to change the second partition to the partition containing the third partition and to bring the electronic apparatus into an operative state, there are a plurality of phases in which the states stored in the storage medium and the states of the partitions are different. The phase information is information for specifying these phases. When the phase information is defined, the phase in the electronic apparatus becomes clear, and thus, an external apparatus may easily progress in the procedure in phases based on the phase information and produce an electronic apparatus.

The disclosure is also applicable to a program and a method executed by a computer. The system, the program, and the method as described above may be implemented as a single apparatus, may be implemented using components provided in a plurality of apparatuses, each element may be provided in an apparatus different from the above described apparatus, and include various forms. The present disclosure may be modified appropriately, for example, a part being software and a part being hardware. Further, the present disclosure is also implemented as a recording medium for a program that controls the system. Obviously, the recording medium for the program may be a magnetic recording medium or a semiconductor memory, and the same may be exactly applied to any recording medium to be developed in the future.

What is claimed is:

1. A method of producing an electronic apparatus, comprising:
in place of first data stored in a first partition of a storage medium, storing setting data stored in a second partition of the storage medium in the first partition;
after storing the setting data in the first partition, changing the second partition to a partition containing a third partition;
storing the setting data stored in the first partition in the third partition;
after storing the setting data in the third partition, storing the first data acquired via an interface in the first partition in place of the setting data stored in the first partition; and
producing an electronic apparatus having the third partition, wherein
the first data is general-purpose data used in a plurality of electronic apparatuses, but not used for production of the electronic apparatus.

2. The method of producing an electronic apparatus according to claim 1, further comprising producing an electronic apparatus having the third partition by controlling an electronic apparatus that operates based on firmware stored in a zeroth partition of the storage medium.

3. The method of producing an electronic apparatus according to claim 1, wherein
the second partition is divided into the third partition and a fourth partition, and
fourth partition data is acquired via the interface and stored in the fourth partition.

4. The method of producing an electronic apparatus according to claim 3, wherein
after the fourth partition data is stored in the fourth partition, the first data is acquired via the interface and stored in the first partition.

5. The method of producing an electronic apparatus according to claim 1, wherein
phase information indicating a phase of production of an electronic apparatus is set to a first state in response to when the storage of the setting data in the first partition is finished, and
the phase information is set to a second state in response to when the storage of the setting data in the third partition is finished.

6. The method of producing an electronic apparatus according to claim 5, wherein
a control apparatus communicating with an electronic apparatus acquires the phase information from the electronic apparatus via the interface, and executes a step of producing an electronic apparatus according to the phase information.

7. A printing apparatus comprising:
an interface;
a processor that updates a storage medium having a first partition and a second partition according to an update program acquired via the interface; and
a printing mechanism that performs printing using first data stored in the first partition, wherein
the processor stores setting data stored in the second partition in the first partition in place of the first data, after storing the setting data in the first partition, changes the second partition to a partition containing a third partition, stores the setting data stored in the first partition in the third partition, and, after storing the setting data in the third partition, stores the first data acquired via the interface in the first partition in place of the setting data stored in the first partition, and
the first data is general-purpose data used in a plurality of electronic apparatuses and is used for printing, but not used for partitioning operation.

8. The printing apparatus according to claim 7, wherein
the storage medium is a semiconductor storage medium.
